(19) United States
(12) Patent Application Publication
(10) Pub. No.: US 2020/0047884 A1
(43) Pub. Date: Feb. 13, 2020

(54) FIRE SUPPRESSION DRONE FOR SKYSCRAPERS

(71) Applicant: DAESHIN IVE Co., Ltd., Busan (KR)

(72) Inventor: GILL DO LEE, Busan (KR)

(21) Appl. No.: 16/537,519

(22) Filed: Aug. 9, 2019

(30) Foreign Application Priority Data
Aug. 13, 2018 (KR) 10-2018-0094336

(51) Int. Cl. B64D 1/16; B64D 47/08; B64C 39/02; A62C 31/00

(52) U.S. Cl. CPC B64D 1/16; B64D 47/08; B64C 2201/12; A62C 31/005; B64C 2201/027; B64C 39/024

(57) ABSTRACT

A fire suppression drone comprises a main body, a plurality of propellers provided on an outer circumference of the main body and driven by a driving motor, a pump provided in the main body and connected to a water feeding vehicle through a water feeding hose, at least one water jet nozzle provided on the outer circumference of the main body to jet water supplied by the pump, a camera provided on the outer circumference of the main body, and a controller connected with the driving motor, the pump, and the camera and connected with a remote controller to be wirelessly communicable with the remote controller, wherein the remote controller includes a monitor, the monitor capable of display, in real-time, an image captured by the camera.

### CROSS-REFERENCE TO RELATED APPLICATION(S)

This application is based on and claims priority under 35 U.S.C. 119 to Korean Patent Application No. 10-2018-0094336, filed on Aug. 13, 2018, in the Korean Intellectual Property Office, the disclosure of which is herein incorporated by reference in its entirety.

### TECHNICAL FIELD

Embodiments of the disclosure relate to drones and, more specifically, to fire suppression drones for use in skyscrapers.

### DESCRIPTION OF RELATED ART

Fire trucks are typically used for suppressing high-rise building fires.

A fire truck has a high-pressure pump for pressurizing water with a high pressure and a water jet nozzle connected with the high-pressure pump. A high-pressure of water is jet to the fire through the water jet nozzle to thereby suppress the fire in the building.

However, conventional fire trucks, by their limited nozzle length, may not work effective for fires that break out on high floors in a high-rise building.

Thus, a need exists for a method of addressing such issues.

There are being recently developed various types of drones which may be controlled by a remote controller for various purposes.

Such a conventional drone has a main body and a plurality of motor-driven propellers provided on the outer circumference of the main body. The drone may perform various operations which other aircraft cannot, such as hovering.

### SUMMARY

According to an embodiment, a fire suppression drone comprises a main body, a plurality of propellers provided on an outer circumference of the main body and driven by a driving motor, a pump provided in the main body and connected to a water feeding vehicle through a water feeding hose, at least one water jet nozzle provided on the outer circumference of the main body to jet water supplied by the pump, a camera provided on the outer circumference of the main body, and a controller connected with the driving motor, the pump, and the camera and connected with a remote controller to be wirelessly communicable with the remote controller, wherein the remote controller includes a monitor, the monitor capable of display, in real-time, an image captured by the camera.

According to an embodiment, the fire suppression drone may further comprise a glass breaking device provided on the outer circumference of the main body and controlled by the controller to break an outer wall glass of a building.

According to an embodiment, the water feeding vehicle may include a drone station on which the fire suppression drone is landed.

According to an embodiment, the fire suppression drone may further comprise a water tank provided on the outer circumference of the main body to store water supplied by the water feeding vehicle.

According to an embodiment, the glass breaking device may include a cylinder extending forwards or backwards, a piston slidable forwards or backwards inside the cylinder, an impact stick extending forward of the cylinder from the piston, and a water feeding pipe having both ends connected with a rear end of the piston and a drain hole of the pump and having a solenoid valve in a middle thereof. As the pump is operated while the solenoid valve is simultaneously open, a high pressure of water discharged from the pump may be supplied to an inside of the cylinder to allow the impact stick to be forced forwards to break the outer wall glass.

According to various embodiments of the disclosure, when a fire breaks out on an upper floor of a high-rise building, the fire suppression drone may fly over to the fire site and jet water directly and thus suppress the fire. As such, the fire suppression drone may effectively suppress fires which break out on high floors conventional fire trucks may not reach.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a side view illustrating a fire suppression drone according to an embodiment;

FIG. 2 is a plan view illustrating a fire suppression drone according to an embodiment;

FIG. 3 is a view illustrating a configuration of a glass breaking device of a fire suppression drone according to an embodiment; and

FIG. 4 is a circuit diagram illustrating a fire suppression drone according to an embodiment.

### DETAILED DESCRIPTION OF EXEMPLARY EMBODIMENTS

Hereinafter, embodiments of the disclosure are described with reference to the accompanying drawings. The same reference numbers or characters may be used to denote the same or substantially the same elements throughout the drawings and the specification. As used herein, the singular forms “a,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

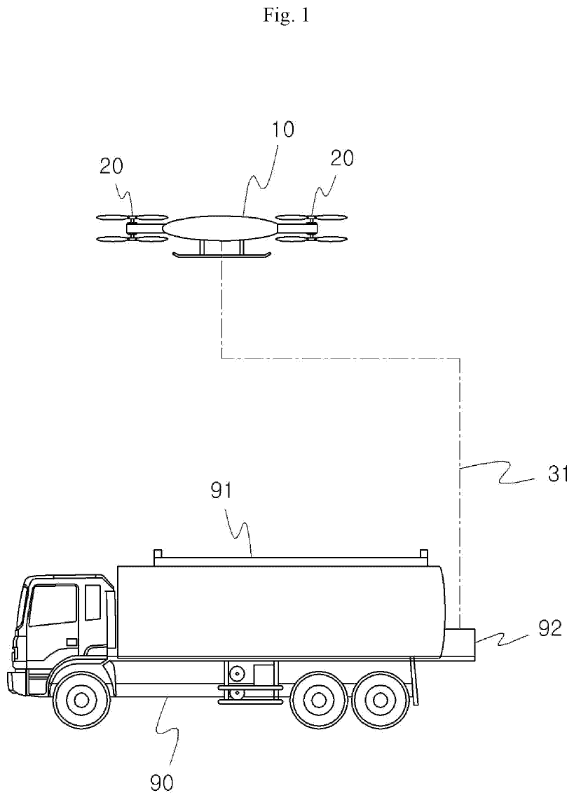

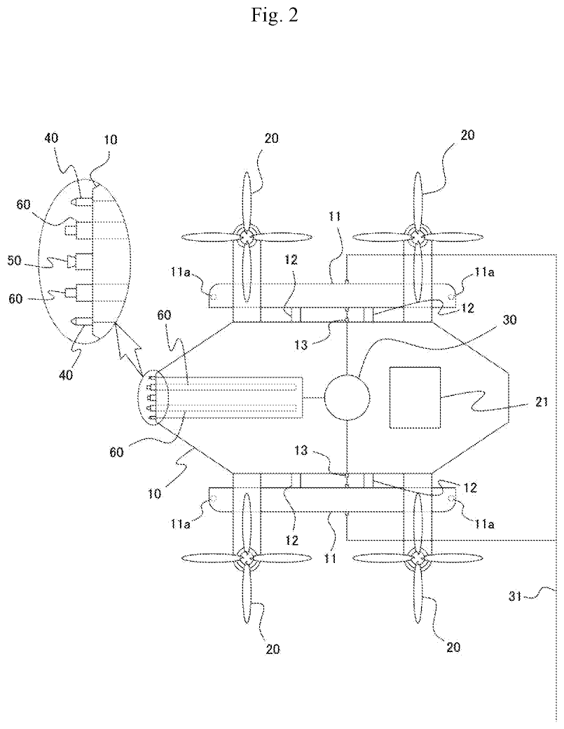

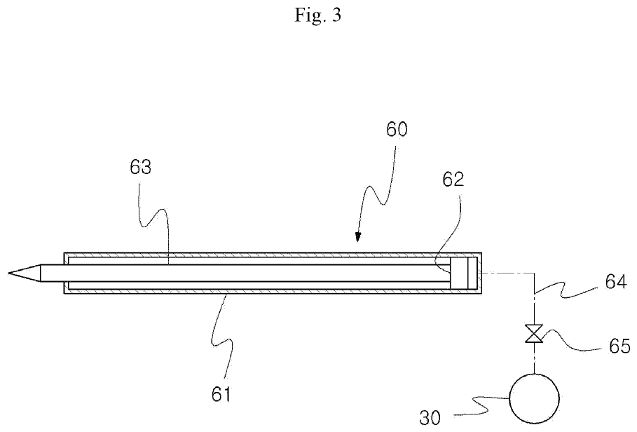

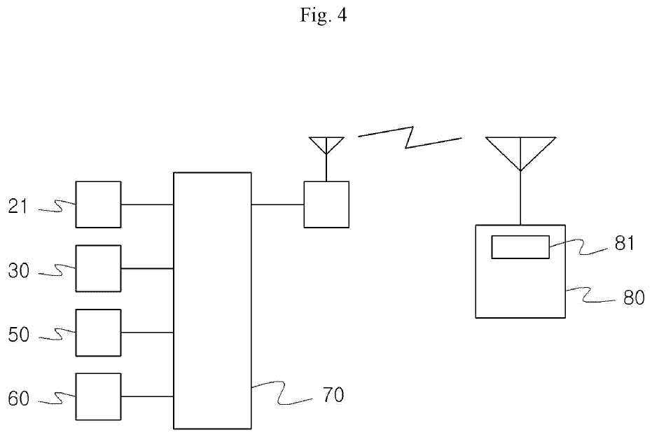

FIG. 1 is a side view illustrating a fire suppression drone according to an embodiment. FIG. 2 is a plan view illustrating a fire suppression drone according to an embodiment. FIG. 3 is a view illustrating a configuration of a glass breaking device of a fire suppression drone according to an embodiment. FIG. 4 is a circuit diagram illustrating a fire suppression drone according to an embodiment. Referring to FIGS. 1 to 4, a fire suppression drone includes a main body 10, a plurality of propellers 20 provided on an outer circumference of the main body 10 and driven or operated by a driving motor 21, a pump 30 provided in the main body 10 and connected to a water feeding vehicle 90 through a water feeding hose 31, at least one water jet nozzle 40 provided on the outer circumference of the main body 10 to jet water supplied by the pump 30, a camera 50 provided on the outer circumference of the main body 10, and a controller 70 connected with the driving motor 21, the pump 30, and the camera 50 and connected with a remote controller 80 to be wirelessly communicable with the remote controller 80.

The main body 10 and the propellers 20 may be substantially the same as those equipped in a conventional drone and no detailed description thereof is given below.

A water tank 11 may be provided on the outer circumference of the main body 10 to store or contain water supplied through the water feeding hose 31.

The water tank 11 may be detachably coupled to a mount provided on the outer circumference of the main body 11.

The pump 30 may be connected through the water feeding hose 31 to the water feeding vehicle 90, pressurize the water supplied through the water feeding hose 31 to a high pressure, and supply the pressurized water to the water jet nozzle 40.

Connecting tabs 13 to which the pump 30 is connected may be provided on the outer circumference of the main body 10. The water tank 11 may be detachably coupled to the connecting tabs 13.

The water feeding hose 31 is configured to be selectively connected to the water tank 11 or the connecting tabs 13.

An automatic discharge valve 11a may be provided on one side of the water tank 11. If the water tank 11 is full of water, a portion of the water supplied through the water feeding hose 31 may be drained out through the automatic discharge valve 11a.

The automatic discharge valve 11a may be provided on the bottom of the water tank 11 so that the drone may be floated by the propulsion that occurs when the pressurized water is discharged downwards through the automatic discharge valve 11a.

The water feeding vehicle 90 has a pump 92 for supplying water, and the water feeding hose 31 may extend above the pump 92.

The water jet nozzles 40 may be provided on both sides of the front surface of the main body 10 to jet water forwards.

The camera 50 may be provided on the front surface of the main body 10 between the water jet nozzles 40 to capture a video of the view in front thereof.

There may be provided two glass breaking devices 60. Referring to FIG. 3, the two glass breaking devices 60 may be positioned at both sides of the water jet nozzles on the front surface of the main body 10. Each glass breaking device 60 may include a cylinder 61 extending forwards or backwards, a piston 62 slidable forwards or backwards inside the cylinder 61, an impact stick 63 extending forward of the cylinder 61 from the piston 62, and a water feeding pipe 64 having both ends connected with a rear end of the piston 62 and a drain hole of the pump 30 and having a solenoid valve 65 in a middle thereof.

As the pump 30 is operated while the solenoid valve 65 is simultaneously open, with the drone positioned adjacent the outer wall glass of the building, a high pressure of water discharged from the pump 30 may be supplied to the inside of the cylinder 61 to force the impact stick 63 forwards, thereby breaking the outer wall glass of the building.

The controller 70 may transmit the image or video captured by the camera 50 to the remote controller 80, and the operation of the driving motor 21, the pump 30, and the glass breaking devices 60 may be controlled by control signals output from the remote controller 80.

The remote controller 80 may have a monitor 81 configured to, in real-time, display the image or video captured by the camera 50.

The water feeding vehicle 90 may have a drone station 91 on which the fire suppression drone may be landed.

As such, when a fire breaks out on an upper floor of a high-rise building, the fire suppression drone may fly over to the fire site and jet water directly and thus suppress the fire. As such, the fire suppression drone may effectively suppress fires which break out on high floors conventional fire trucks may not reach.

Fires breaking out indoors may be effectively suppressed by the glass breaking devices 60 which are controlled by the controller 70.

As necessary, the water tank 11 and the water feeding hose 31 may be separated so that the fire suppression drone is used only for the purpose of breaking glasses.

As the water feeding vehicle 90 has the drone station 91 for takeoff or landing of the fire suppression drone, the fire suppression drone may be effectively used in any place where it is hard for the drone to take off or land.

The water tank 11 is provided on the outer circumference of the main body 10 to store water supplied by the water feeding vehicle 90. Thus, when water supply by the water feeding vehicle 90 is cut off or it is required to suppress a fire which breaks out in high places which the water feeding hose 31 does not reach, the fire may be suppressed using the water stored in the water tank 11.

The glass breaking device includes a cylinder extending forwards or backwards, a piston slidable forwards or backwards inside the cylinder, an impact stick extending forward of the cylinder from the piston, and a water feeding pipe having both ends connected with a rear end of the piston and a drain hole of the pump and having a solenoid valve in a middle thereof, and wherein as the pump is operated while the solenoid valve is simultaneously open, a high pressure of water discharged from the pump is supplied to an inside of the cylinder to allow the impact stick to be forced forwards to break the outer wall glass. As such, the fire suppression drone may break glasses with a simplified structure in an easy and simple manner.

While the disclosure has been shown and described with reference to exemplary embodiments thereof, it will be apparent to those of ordinary skill in the art that various changes in form and detail may be made thereto without departing from the spirit and scope of the disclosure as defined by the following claims.

What is claimed is:

1. A fire suppression drone, comprising:
a main body;
a plurality of propellers provided on an outer circumference of the main body and driven by a driving motor;
a pump provided in the main body and connected to a water feeding vehicle through a water feeding hose;
at least one water jet nozzle provided on the outer circumference of the main body to jet water supplied by the pump;
a camera provided on the outer circumference of the main body; and
a controller connected with the driving motor, the pump, and the camera and connected with a remote controller to be wirelessly communicable with the remote controller, wherein the remote controller includes a monitor, the monitor capable of display, in real-time, an image captured by the camera.

2. The fire suppression drone of claim 1, further comprising a glass breaking device provided on the outer circumference of the main body and controlled by the controller to break an outer wall glass of a building.

3. The fire suppression drone of claim 1, wherein the water feeding vehicle includes a drone station on which the fire suppression drone is landed.

4. The fire suppression drone of claim 1, further comprising a water tank provided on the outer circumference of the main body to store water supplied by the water feeding vehicle.

5. The fire suppression drone of claim 2, wherein the glass breaking device includes a cylinder extending forwards or backwards, a piston slidable forwards or backwards inside the cylinder, an impact stick extending forward of the cylinder from the piston, and a water feeding pipe having both ends connected with a rear end of the piston and a drain hole of the pump and having a solenoid valve in a middle thereof, and wherein as the pump is operated while the solenoid valve is simultaneously open, a high pressure of water discharged from the pump is supplied to an inside of the cylinder to allow the impact stick to be forced forwards to break the outer wall glass.
